(19) United States
(12) Patent Application Publication
(10) Pub. No.: US 2003/0037869 A1
(43) Pub. Date: Feb. 27, 2003

(54) Bonding of glazing panels

(76) Inventors: Christopher Davies, Kidwelly (GB); Robert Marc Clement, Rhos (GB)

Correspondence Address: MERCHANT & GOULD PC, P.O. BOX 2903, MINNEAPOLIS, MN, 55402-0903, US

(21) Appl. No.: 10/181,609

(22) PCT Filed: Jan. 25, 2001
(86) PCT No.: PCT/GB01/00316

(30) Foreign Application Priority Data
Jan. 25, 2000 (GB) 0001657.6

(51) Int. Cl. B32B 31/00

(52) U.S. Cl. 156/272.2; 156/275.5

(57) ABSTRACT

A glazing panel is fitted in a frame by placing the glazing panel in register with the frame with soft state bonding material interposed. An energy field is then set up to act upon the bonding material the energy field acting to promote curing of the bonding material. Preferably a microwave energy field is set up and the energy is applied for a predetermined period, typically less than 60 seconds.

The present invention relates to bonding of glazing panels, and in particular to bonding of vehicular glazing panels such as windshields (windscreens), rear window panels and side window panels.

Conventionally, glazing panels (whether for architectural or vehicular use) may be bonded to supporting frames by means of bonding material interposed between the frame and the glazing panel. The bonding material is typically applied as a bead around the periphery of the panel or frame in relatively softened condition; subsequently the bonding material cures (hardens) to hold the glazing panel securely bonded in the frame.

Polyurethane materials are frequently used for the bonding material. A commonly used polyurethane bonding material for glazing panels in vehicular applications is of a type which cures in the presence of moisture. Typically times for known moisture cure polyurethane bonding materials to cure sufficiently (especially to reach permitted drive away time strength) following fitting or replacement of vehicular glazing panels, can be up to four hours, particularly where humidity is low such as is the case in cold weather conditions.

Heat curable bonding materials are now available.

According to the invention, there is provided a method of fitting a glazing panel in a frame the method comprising:

i) applying bonding material in a relatively softened state about the periphery of the glazing panel or the frame;

ii) placing the glazing panel in register with the frame with the bonding material interposed therebetween; and

iii) setting up an energy field acting on the bonding material, the energy field acting to promote curing of the bonding material.

The energy field promotes heating of the bonding material and hence curing of the heat curable bonding material.

Desirably, the energy field is substantially uniform through the bonding material. This promotes substantially uniform heating of the bonding material throughout the body of the material which results in uniform curing rate and avoids localised “hot spots”.

The energy field preferably comprises an electromagnetic energy field. Desirably the energy comprises microwave energy, preferably directed by a microwave waveguide. As an alternative, a radio frequency (RF) heating method may be utilised. A microwave energy field is particularly preferred and found to be particularly efficient in producing rapid and thorough curing throughout a localised volume of the bonding material.

It is preferred that the energy is supplied over a predetermined period at a predetermined intensity, in order to supply a finite amount of energy. The duration of the energy supply is preferably substantially at or below 90 seconds per curing exposure (more preferably at or below 60 seconds per curing exposure, most preferably at or below 40 to 50 seconds).

Desirably, the energy field is localised to act upon a localised volume of bonding material. The localised energy field is preferably moved about the glazing panel periphery/frame to effect successive localised curing of spaced portions of bonding material to effect complete curing of the bonding material bonding the glazing panel to the frame.

The bonding material preferably comprises a polyurethane material.

According to a second aspect, the invention comprises apparatus for bonding a glazing panel in a frame the apparatus comprising means for setting up an energy field acting on bonding material interposed between the glazing panel and the frame, the energy field acting to promote curing of the bonding material.

Preferred features of the apparatus will be readily derived from the foregoing preferred features of the method according to the invention.

The invention will now be further described with reference to the following examples:

### EXAMPLE 1

A bonding bead of heat curable polyurethane in a softened state at ambient conditions was applied around a vehicle frame opening for receiving a windscreen. A windscreen was subsequently placed in register with the bead. A microwave waveguide was held adjacent the windscreen in the region of the bonding bead and microwave radiation supplied to generate substantially uniform microwave energy field of approximately 0.0.46 wattcm⁻³ intersecting a localised volume of the bonding bead of approximately 10 cm³.

Energy at the level specified was supplied to the localised 10 cm³ volume of the bead for approximately 45 seconds resulting in approximate total energy supplied to the localised volume of approximately 22 Joules. Using the parameters specified it is estimated it is estimated that immediately following removal of the microwave field the localised portion of the bonding bead was approximately 80% cured becoming fully cured (with no further supply of energy) after 2 minutes.

Immediately following the 45 second exposure the waveguide was moved to supply microwave energy to an adjacent localised volume of the bonding bead. Successively exposing localised volumes and advancing the waveguide about the periphery resulted in the entire length of the bonding bead around the periphery of the glazing panel being cured.

### EXAMPLE 2

The technique used was identical to that described in Example 1, excepting that exposure of localised 10 cm³ volumes of the bead was for 60 seconds. This resulted in full curing of the respective localised volume.

1. A method of fitting a glazing panel in a frame the method comprising:
i) applying bonding material in a relatively softened state about the periphery of the glazing panel or the frame;
ii) placing the glazing panel in register with the frame with the bonding material interposed therebetween; and
iii) setting up an energy field acting on the bonding material, the energy field acting to promote curing of the bonding material.

2. A method according to claim 1, wherein the bonding material is heat curable.

3. method according to claim 1 or claim 2, wherein the energy field promotes heating of the bonding material and hence curing of the heat curable bonding material.

4. A method according to any preceding claim, wherein the energy field is substantially uniform through the bonding material.

5. A method according to any preceding claim, wherein the energy field comprises an electromagnetic energy field.

6. A method according to any preceding claim, wherein the energy comprises microwave energy.

7. A method according to claim 6, wherein the microwave energy is directed by a microwave waveguide.

8. A method according to any of claims 1 to 4, wherein Radio Frequency (RF) energy is used to set up the energy field.

9. A method according to any preceding claim, wherein the duration of the energy supply is substantially at or below 60 seconds per curing exposure.

10. A method according to any preceding claim, wherein the energy field is localised to act upon a localised volume of bonding material.

11. A method according to claim 10, wherein the localised energy field is moved about the glazing panel periphery/frame to effect localised promoted curing of successive spaced portions of bonding material, thereby to effect substantially complete promoted curing of the bonding material bonding the glazing panel to the frame.

12. A method according to any preceding claim, wherein the bonding material comprises a polyurethane material.

13. A method according to any preceding claim, wherein:
i) a bonding bead of heat curable polyurethane in a softened state at ambient conditions is applied around a vehicle frame opening for receiving a windscreen;
ii) a windscreen is placed in register with the bead;
iii) a microwave waveguide is positioned adjacent the windscreen in the region of the bonding bead and microwave radiation supplied to generate substantially uniform microwave energy field intersecting a localised volume of the bonding bead.

14. A method according to claim 13, wherein the energy applied generates a substantially uniform energy field of 0.046 wattcm⁻³±20%.

15. A method according to claim 14, wherein the energy applied generates a substantially uniform energy field of 0.046 wattcm⁻³±10%.

16. A method according to any of claims 13 to 15, wherein the localised volume to which the energy field is applied is approximately 10 cm³±10%.

17. A method according to any of claims 13 to 16, wherein the energy field is applied for a time substantially in the range 30 seconds to 60 seconds.

18. A method according to claim 17, wherein the energy field is applied for a time substantially in the range 40 seconds to 50 seconds.

19. A method according to any of claims 13 to 18, wherein following the predermined duration exposure to the energy field, the waveguide is moved to supply microwave energy to an adjacent localised volume of the bonding bead, thereby successively exposing localised volumes and advancing the waveguide about the periphery resulting in substantially the entire length of the bonding bead around the periphery of the glazing panel being cured to a required degree.

20. A method according to any of claims 1 to 19, wherein the glazing panel comprises a vehicular glazing panel.

21. Apparatus for bonding a glazing panel in a frame the apparatus comprising means for setting up an energy field acting on bonding material interposed between the glazing panel and the frame, the energy field acting to promote curing of the bonding material.
